(19) United States
(12) Patent Application Publication
(10) Pub. No.: US 2022/0320867 A1
(43) Pub. Date: Oct. 6, 2022

(54) GRID SYSTEM, ELECTRIC POWER TRANSFER METHOD, AND STORAGE MEDIUM

(71) Applicant: HONDA MOTOR CO., LTD., Tokyo (JP)

(72) Inventor: Noriyuki Abe, Tokyo (JP)

(21) Appl. No.: 17/681,857

(22) Filed: Feb. 28, 2022

(30) Foreign Application Priority Data
Mar. 31, 2021 (JP) 2021-060322

(51) Int. Cl. H02J 3/32; H02J 3/38; H02J 7/00; B60L 50/60; B60L 58/12; B60L 55/00; B60L 53/63; B60L 8/00

(52) U.S. Cl. CPC H02J 3/322; H02J 3/381; H02J 7/0048; B60L 50/60; B60L 58/12; B60L 55/00; B60L 53/63; B60L 8/003; H02J 2300/24; H02J 2310/12; H02J 2310/48

(57) ABSTRACT

A grid system in which a first storage battery and a second storage battery can be connected and electric power can be transferred between the first storage battery and the second storage battery, includes: an electric power value setting unit that sets an electric power value per a predetermined amount of electric power according to an electric power state of either or both of the first storage battery and the second storage battery; and an electric power transfer control unit that adjusts an amount of electric power to be transferred between the first storage battery and the second storage battery on the basis of the electric power value.

### CROSS-REFERENCE TO RELATED APPLICATION

Priority is claimed on Japanese Patent Application No. 2021-060322, filed Mar. 31, 2021, the content of which is incorporated herein by reference.

### BACKGROUND OF THE INVENTION

### Field of the Invention

The present invention relates to a grid system, an electric power transfer method, and a storage medium.

### Description of Related Art

In the related art, having an electrically driven vehicle such as an electric vehicle (EV) with a power supply function which includes an in-vehicle storage battery and has a function of connecting to a household power supply (a system power supply) has not been taken into account in a home energy management system (HEMS).

With regard to electrically driven vehicles, a technique for flexibly utilizing surplus electric power generated in photovoltaic power generation while storing the amount of electric power required for driving the electric vehicle according to an intended use of a user has been disclosed (see Japanese Patent No. 6783411, for example). This technique is a charging and discharging device that charges and discharges a storage battery mounted on an electrically driven vehicle in a residential building in which a photovoltaic power generation system has been installed. The charging and discharging device includes an electric power conversion unit that charges and discharges the storage battery, a charge amount management unit that manages target charge amount information indicating a target charge amount of the storage battery, a time management unit that manages charge amount adjustment time information indicating a time period for performing an operation of bringing a charge amount of the storage battery to the target charge amount by charging or discharging the storage battery, and an operation control unit that controls the electric power conversion unit on the basis of the target charge amount information and the charge amount adjustment time information.

### SUMMARY OF THE INVENTION

In a case where there is no coordination with vehicle charging and discharging control such as requesting discharging even when a state of charge (SOC) of the EV vehicle is low, or requesting charging even when the SOC is high, various inconveniences may occur.

In a case where an HEMS is used in a single-person household or a nuclear family household, when the user can be inside the house and not in the vehicle, the user can be in the vehicle and not inside the house, or the like, it is assumed that in the control of the HEMS, energy use may be restricted in spite of the absence of a user, and it is also conceivable that uneconomical and inefficient situations will occur.

These problems may occur in a situation where a residential building such as a house and a vehicle are connected one-to-one, but it is conceivable that this will be significant also in a grid system in which vehicles and residential buildings are connected to enable energy linking.

An aspect according to the present invention has been made in consideration of such circumstances, and an object of the present invention is to provide a grid system, an electric power transfer method, and a storage medium capable of adjusting the amount of electric power to be transferred.

In order to solve the above problems and achieve the above object, the present invention has employed the following aspects.

(1) According to an aspect of the present invention, there is provided a grid system in which a first storage battery and a second storage battery can be connected and electric power can be transferred between the first storage battery and the second storage battery, the grid system includes an electric power value setting unit that sets an electric power value per a predetermined amount of electric power according to an electric power state of either or both of the first storage battery and the second storage battery; and an electric power transfer control unit that adjusts an amount of electric power to be transferred between the first storage battery and the second storage battery on the basis of the electric power value.
(2) In the aspect of (1), the first storage battery may be a residential building storage battery installed in a residential building and the residential building storage battery may store electric power generated by a photovoltaic power generation device installed in the residential building, and the second storage battery may be a vehicle storage battery installed in a vehicle and the vehicle storage battery may store electric power generated by a photovoltaic power generation device installed in the vehicle.
(3) In the aspect of (1) or (2), a first consumer having either or both of the first storage battery and the second storage battery can transfer electric power with respect to a second consumer having a third storage battery, and the electric power value setting unit may set an electric power value per a predetermined amount of electric power on the basis of an electric power state of the third storage battery in a case where electric power is transferred between the first consumer and the second consumer.
(4) In the aspect of any one of (1) to (3), the grid system may further include an intra-regional electric power line that electrically connects a predetermined geographical range, and the electric power value setting unit may set an electric power value per a predetermined amount of electric power on the basis of an electric power state of the intra-regional electric power line.
(5) In the aspect of any one of (1) to (4), the second storage battery may be a vehicle storage battery installed in a vehicle and the vehicle storage battery may store electric power generated by a photovoltaic power generation device installed in the vehicle, and the electric power transfer control unit may give priority to a vehicle having the photovoltaic power generation device over other vehicles not having the photovoltaic power generation device.
(6) In the aspect of any one of (1) to (5), the electric power state may include use electric power and supply electric power which is electric power supplied from the vehicle to the residential building, and the electric power value setting unit may set an electric power value of the supply electric power to be higher than an electric power value of the use electric power.
(7) In the aspect of any one of (1) to (5), the first storage battery may be a residential building storage battery installed in a residential building and the second storage battery may be a vehicle storage battery installed in a vehicle, and the electric power value setting unit may lower an electric power value of the residential building storage battery in a case where a user is not in the residential building and may lower an electric power value of the vehicle storage battery in a case where a user is not in the vehicle.
(8) In the aspect of any one of (1) to (5), the electric power state may include an SOC of a storage battery, and the electric power value setting unit may set an electric power value of the first storage battery or the second storage battery having an SOC lower than a first reference value to be higher than an electric power value of the first storage battery or the second storage battery having an SOC higher than the first reference value.
(9) In the aspect of any one of (1) to (5), the electric power state may include an SOC of a storage battery, and the electric power value setting unit may increase or decrease the electric power value on the basis of an increase or decrease of the SOC.
(10) In the aspect of any one of (1) to (5), the grid system may further include a first intra-regional electric power line that electrically connects a predetermined geographical range, the electric power state may include connection electric power which is electric power supplied from the first intra-regional electric power line and mobile electric power which is electric power supplied from the outside of the first intra-regional electric power line, and the electric power value setting unit may set an electric power value of the connection electric power to be higher than an electric power value of the mobile electric power.
(11) In the aspect of any one of (1) to (5), the electric power state may include a first intra-grid electric power transmitted through a first intra-regional electric power line that electrically connects a predetermined geographical range and a second intra-grid electric power supplied to the first intra-regional electric power line from a second intra-regional electric power line different from the first intra-regional electric power line, and the electric power value setting unit may set an electric power value of the first intra-grid electric power to be higher than an electric power value of the second intra-grid electric power.
(12) In the aspect of any one of (1) to (5), the electric power state may include a first grid internal electric power transmitted through a first intra-regional electric power line that electrically connects a predetermined geographical range and a second grid internal electric power supplied to the first intra-regional electric power line from a second intra-regional electric power line different from the first intra-regional electric power line, and in a case where the total of SOCs of the first grid internal electric power is lower than a second reference value, the electric power value setting unit may set an electric power value of the second grid internal electric power to be higher than an electric power value of the first grid internal electric power.
(13) In the aspect of any one of (1) to (5), the grid system may further include an intra-regional electric power line that electrically connects a predetermined geographical range, and the electric power transfer control unit may perform control such that electric power is supplied from the intra-regional electric power line to a use storage battery or either or both of the first storage battery and the second storage battery having an SOC higher than a predetermined reference value.
(14) In the aspect of any one of (1) to (5), a first consumer having either or both of the first storage battery and the second storage battery can transfer electric power with respect to a second consumer having a third storage battery, and the electric power transfer control unit may perform control such that electric power is supplied from the third storage battery to a use storage battery or either or both of the first storage battery and the second storage battery having an SOC higher than a predetermined reference value.
(15) In the aspect of any one of (1) to (5), the electric power transfer control unit may perform control such that electric power is supplied from a photovoltaic power generation device to a use storage battery or either or both of the first storage battery and the second storage battery having an SOC higher than a predetermined reference value.
(16) According to another aspect of the present invention, there is provided an electric power transfer method executed by a grid system in which a first storage battery and a second storage battery can be connected and electric power can be transferred between the first storage battery and the second storage battery, the method includes a step of setting an electric power value per a predetermined amount of electric power according to an electric power state of either or both of the first storage battery and the second storage battery; and a step of adjusting an amount of electric power to be transferred between the first storage battery and the second storage battery on the basis of the electric power value.
(17) According to still another aspect of the present invention, there is provided a computer-readable non-transitory storage medium that stores a computer program causing a computer to execute: a step of setting an electric power value per a predetermined amount of electric power according to an electric power state of either or both of a first storage battery and a second storage battery; and a step of adjusting an amount of electric power to be transferred between the first storage battery and the second storage battery on the basis of the electric power value.

According to (1) to (17), the amount of electric power to be transferred can be adjusted.

### BRIEF DESCRIPTION OF THE DRAWINGS

FIG. 1 is a diagram showing Example 1 of a schematic configuration of a grid system according to the present embodiment.

FIG. 2 is a diagram for explaining an example of a residential building and a vehicle included in the grid system according to the present embodiment.

FIG. 3 is a diagram showing an example of an operation of the grid system according to the present embodiment.

FIG. 4A is a diagram for explaining Example 1 of a setting example of an electric power value of the grid system according to the present embodiment.

FIG. 4B is a diagram for explaining Example 2 of a setting example of an electric power value of the grid system according to the present embodiment.

FIG. 5 is a flowchart showing an example of an operation of the grid system according to the present embodiment.

FIG. 6 is a diagram showing Example 2 of a schematic configuration of a grid system according to the present embodiment.

FIG. 7 is a diagram showing Example 3 of a schematic configuration of a grid system according to the present embodiment.

FIG. 8 is a diagram showing Example 4 of a schematic configuration of a grid system according to the present embodiment.

### DETAILED DESCRIPTION OF THE INVENTION

Next, a grid system and a method executed by the grid system of the present embodiment will be described with reference to the drawings. Embodiments which will be described below are merely examples, and the embodiments to which the present invention is applied are not limited to the following embodiments. In all the drawings for explaining the embodiments, the same reference signs are used for those having the same function, and the repeated description is omitted.

The term “on the basis of XX” as used herein means “on the basis of at least XX” and includes a case where it is on the basis of another element in addition to XX. The term “on the basis of” is not limited to the case where XX is used directly, but also includes a case where it is on the basis of those obtained by calculating or processing XX. “XX” is an arbitrary element (for example, arbitrary information).

### EMBODIMENTS

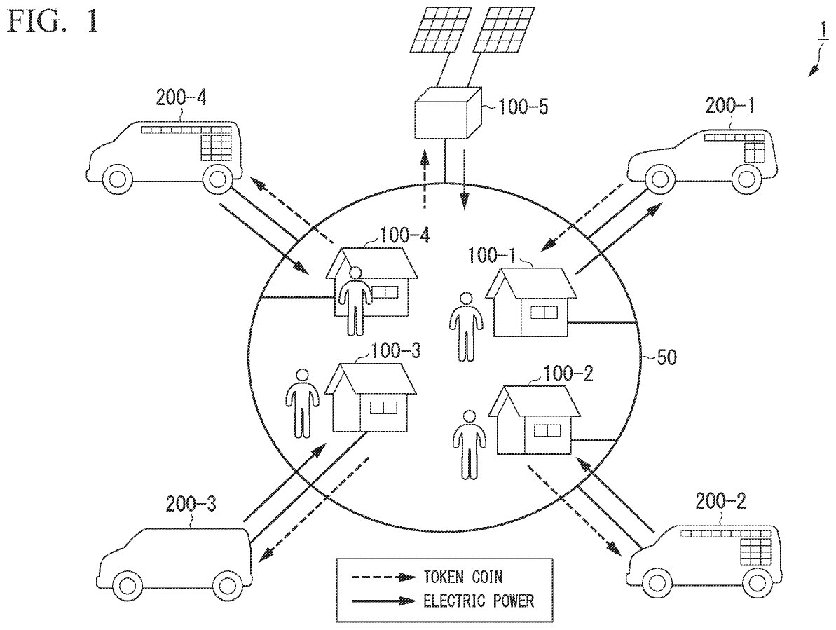

Hereinafter, embodiments of the present invention will be described in detail with reference to the drawings. FIG. 1 is a diagram showing Example 1 of a schematic configuration of a grid system according to the present embodiment.

A grid system 1 according to the present embodiment includes an intra-regional electric power line 50. The intra-regional electric power line 50 electrically connects a predetermined geographical range. The intra-regional electric power line 50 includes a transmission line for mutually accommodating electric power that can be used in a region in each residential building. Each of a residential building 100-1 to a residential building 100-5 is connected to the intra-regional electric power line 50 via an electric power line. Each of the residential building 100-1 to the residential building 100-5 receives supply of electric power from the intra-regional electric power line 50. Each of the residential building 100-1 to the residential building 100-5 performs electric power line carrier communication via the intra-regional electric power line 50 and the electric power line.

Electric power is supplied to a regional transformer (not shown) from system electric power. The regional transformer converts the electric power supplied from the system electric power into a voltage and current suitable for transmission on the intra-regional electric power line 50. An example of the voltage and current on the intra-regional electric power line 50 is a 200 V three-phase three-wire system, a 200 V single-phase two-wire system, a 100 V single-phase two-wire system, or the like. The regional transformer supplies the electric power converted into the voltage and current suitable for transmission on the intra-regional electric power line 50 to the intra-regional electric power line 50. An example of the intra-regional electric power line 50 is a circular system, a dendritic system, a low pressure banking system, or a regular network system. In the present embodiment, as an example, description will be continued with a case where the intra-regional electric power line 50 is a circular system will.

Each of the residential building 100-1 to the residential building 100-5 includes a photovoltaic power generation device and a residential building storage battery. The residential building storage battery stores the electric power generated by the photovoltaic power generation device.

An electrically driven vehicle such as an electric vehicle (EV) and a plug-in hybrid vehicle (PHV) can be connected to the intra-regional electric power line 50 via the electric power line. In the example shown in FIG. 1, a vehicle 200-1 is connected to the intra-regional electric power line 50 in the vicinity of the residential building 100-1 via the electric power line, a vehicle 200-2 is connected to the intra-regional electric power line 50 in the vicinity of the residential building 100-2 via the electric power line, a vehicle 200-3 is connected to the intra-regional electric power line 50 in the vicinity of the residential building 100-3 via the electric power line, and a vehicle 200-4 is connected to the intra-regional electric power line 50 in the vicinity of the residential building 100-4 via the electric power line.

Each of the vehicle 200-1 to the vehicle 200-4 includes a vehicle storage battery. Among the vehicle 200-1 to the vehicle 200-4, each of the vehicle 200-1, the vehicle 200-2, and the vehicle 200-4 includes a photovoltaic power generation device. Each of the vehicle 200-1, the vehicle 200-2, and the vehicle 200-4 stores electric power generated by the photovoltaic power generation device in the vehicle storage battery.

When each of the vehicle 200-1 to the vehicle 200-4 is connected to the intra-regional electric power line 50, each of the vehicle 200-1 to the vehicle 200-4 can transfer electric power and perform electric power line carrier communication with respect to each of the residential building 100-1 to the residential building 100-5 via the intra-regional electric power line 50. In a case where each of the vehicle 200-1 to the vehicle 200-4 transfers electric power with respect to each of the residential building 100-1 to the residential building 100-5, each of the vehicle 200-1 to the vehicle 200-4 sets an electric power value as a consideration for the electric power and transfers the set electric power value.

When the vehicle 200-1 to the vehicle 200-4 are connected to the intra-regional electric power line 50, the vehicle 200-1 to the vehicle 200-4 can transfer electric power and perform electric power line carrier communication via the intra-regional electric power line 50. In a case where the vehicle 200-1 to the vehicle 200-4 transfer electric power, the vehicle 200-1 to the vehicle 200-4 set an electric power value as a consideration for the electric power and transfer the set electric power value.

The residential building 100-1 to the residential building 100-5 can transfer electric power and perform electric power line carrier communication via the intra-regional electric power line 50. In a case where the residential building 100-1 to the residential building 100-5 transfer electric power, the residential building 100-1 to the residential building 100-5 set an electric power value as a consideration for the electric power and transfer the set electric power value.

Hereinafter, any residential building among the residential building 100-1 to the residential building 100-5 will be referred to as a residential building 100. Any vehicle among the vehicle 200-1 to the vehicle 200-4 will be referred to as a vehicle 200. The residential building 100 and the vehicle 200 will be described in sequence.

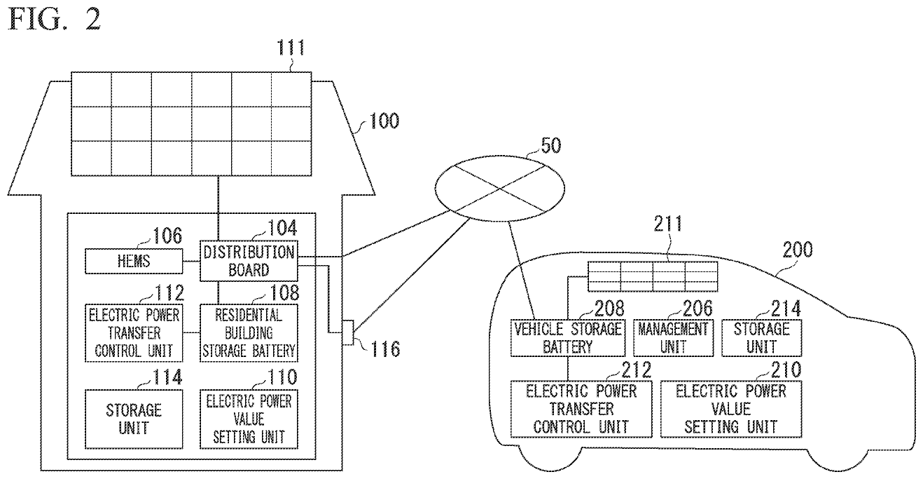

FIG. 2 is a diagram for explaining an example of a residential building and a vehicle included in the grid system according to the present embodiment.

### (Residential Building 100)

The residential building 100 includes a distribution board 104, an HEMS 106, a residential building storage battery 108, an electric power value setting unit 110, a photovoltaic power generation device 111, an electric power transfer control unit 112, a storage unit 114, and a connecting portion 116.

The system electric power supplied from an electric power company is supplied to the distribution board 104 via the regional transformer, the intra-regional electric power line 50, and the electric power line. The distribution board 104 supplies the electric power supplied from the system electric power to an electric power supply destination. For example, as the electric power supply destination, a home appliance (not shown), a housing facility (not shown), or the like provided in the residential building 100 is connected to the distribution board 104. The distribution board 104 supplies the electric power from the system electric power to the home appliance, the housing facility, or the like.

The photovoltaic power generation device 111 and the residential building storage battery 108 are connected to the distribution board 104. The distribution board 104 supplies the electric power generated by the photovoltaic power generation device 111 to the residential building storage battery 108. The residential building storage battery 108 stores the electric power supplied from the distribution board 104.

The connecting portion 116 is connected to the distribution board 104 via a cable. The connecting portion 116 can be connected to the intra-regional electric power line 50 via the electric power line. The connecting portion 116 is a connector that electrically connects the distribution board 104 and the intra-regional electric power line 50 by being connected to the intra-regional electric power line 50 through the electric power line. The connector includes a terminal of the electric power line for supplying the electric power from the distribution board 104 to the intra-regional electric power line 50. The connector includes a terminal of the electric power line for supplying the electric power supplied from the intra-regional electric power line 50 to the distribution board 104. The HEMS 106, an HEMS 106 installed in another residential building, and the vehicle 200 which are connected to the intra-regional electric power line 50 can perform electric power line carrier communication via the connector.

In a case where the vehicle 200 is connected to the intra-regional electric power line 50 via the electric power line, the electric power stored in the residential building storage battery 108 of the residential building 100 can be supplied to the vehicle 200 via the distribution board 104, the connecting portion 116, and the intra-regional electric power line 50.

In a case where the vehicle 200 is connected to the intra-regional electric power line 50 via the electric power line, the electric power stored in the vehicle 200 can be supplied to the residential building storage battery 108 of the residential building 100 via the intra-regional electric power line 50, the connecting portion 116, and the distribution board 104. Here, the electric power taken out from the vehicle 200 is a direct current, but it is converted into an alternating current of 50 Hz or 60 Hz in a 100 V single-phase two-wire system by an inverter (not shown) provided in the vehicle 200 and is supplied to the intra-regional electric power line 50.

With the control of HEMS 106, the residential building storage battery 108 is discharged, and the electric power obtained by discharging the residential building storage battery 108 is supplied to the vehicle 200 via the distribution board 104, the connecting portion 116, and the intra-regional electric power line 50. In the vehicle 200, the vehicle storage battery stores the electric power from the intra-regional electric power line 50.

According to the control of HEMS 106, the vehicle storage battery of the vehicle 200 is discharged, and the electric power obtained by discharging the vehicle storage battery is supplied to the residential building 100 via the intra-regional electric power line 50, the connecting portion 116, and the distribution board 104. In the residential building 100, the residential building storage battery 108 stores the electric power from the distribution board 104.

The HEMS 106 acquires information specifying the electric power stored in the residential building storage battery 108, identification information for the vehicle storage battery (hereinafter referred to as “vehicle storage battery ID”), and information specifying the electric power stored in a vehicle storage battery 208. An example of the vehicle storage battery ID is a media access control address (a MAC address). Hereinafter, description will be continued with a case where the MAC address is applied as the vehicle storage battery ID.

The HEMS 106 requests charging to the residential building storage battery 108 and requests discharging to the vehicle storage battery 208 corresponding to the vehicle storage battery ID on the basis of either or both of the acquired information specifying the electric power stored in the residential building storage battery 108 and the acquired information specifying the electric power stored in the vehicle storage battery 208.

Alternatively, the HEMS 106 requests discharging to the residential building storage battery 108 and requests charging to the vehicle storage battery 208 corresponding to the vehicle storage battery ID on the basis of either or both of the acquired information specifying the electric power stored in the residential building storage battery 108 and the acquired information specifying the electric power stored in the vehicle storage battery 208.

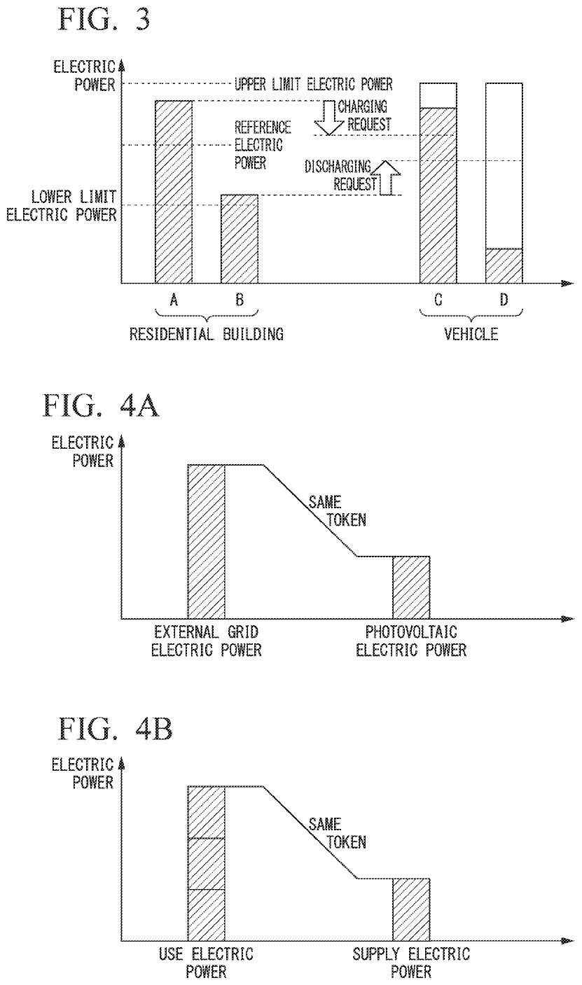

FIG. 3 is a diagram showing an example of an operation of the grid system according to the present embodiment.

In FIG. 3, A and B indicate the electric power stored in the residential building storage battery 108 of the residential building 100, and C and D indicate an SOC of the vehicle storage battery of the vehicle 200. The electric power stored in the residential building storage battery 108 is managed on the basis of a lower limit electric power, a reference electric power, and an upper limit electric power. Here, an electric power storage amount increases in the order of the lower limit electric power, the reference electric power, and the upper limit electric power. The reference electric power is preferably constant.

A is a case where the electric power storage amount is larger than the reference electric power and smaller than the upper limit electric power. In this case, the HEMS 106 requests the residential building storage battery 108 to be discharged and requests the vehicle storage battery of the vehicle 200 to be charged in order to supply the electric power stored in the residential building storage battery 108. As a result, the residential building storage battery 108 is discharged, and the electric power obtained by discharging the residential building storage battery 108 is supplied to the vehicle 200. In the vehicle 200, the vehicle storage battery 208 stores the electric power supplied from the residential building storage battery 108.

B is a case where the electric power storage amount is smaller than the reference electric power and larger than the lower limit electric power. In this case, the HEMS 106 requests the residential building storage battery 108 to be charged and requests the vehicle storage battery of the vehicle 200 to be discharged in order to store the electric power in the residential building storage battery 108. As a result, the vehicle storage battery is discharged, and the electric power obtained by discharging the vehicle storage battery is supplied to the residential building 100. In the residential building 100, the residential building storage battery 108 stores the electric power supplied from the vehicle storage battery.

With such a configuration, the electric power stored in the residential building storage battery 108 can be supplied to the vehicle storage battery of the vehicle 200, and the electric power supplied to the vehicle storage battery of the vehicle 200 can be supplied to another residential building storage battery 108. Therefore, the vehicle 200 can be used as an electric power buffer. Returning to FIG. 2, description will be continued.

The HEMS 106 monitors the current between the connecting portion 116 and the intra-regional electric power line 50 connected to the connecting portion 116 and grasps whether the vehicle storage battery of the vehicle 200 is charged via the connecting portion 116 and the intra-regional electric power line 50 or the electric power stored in the vehicle storage battery of the vehicle 200 is supplied to the distribution board 104 via the intra-regional electric power line 50 and the connecting portion 116 due to the discharging of the vehicle storage battery of the vehicle 200 and the supplied electric power is stored in the residential building storage battery 108.

The HEMS 106 is configured to include a computer and includes, for example, a central processing unit (CPU), a read only memory (ROM), a random access memory (RAM), and input and output ports, and the CPU, the ROM, the RAM, and the input and output ports are connected to each other via buses such as an address bus, a data bus, and a control bus.

The electric power value setting unit 110 sets an electric power value per a predetermined amount of the electric power. Specifically, the electric power value setting unit 110 sets an electric power value per a predetermined amount of the electric power with respect to an electric power value setting unit 210 of the vehicle 200 according to an electric power state of either or both of the residential building storage battery 108 and the vehicle storage battery 208.

An example of the electric power value is a token coin. The token coin is a unique cryptographic asset (a virtual currency) issued by a company or an individual using the existing blockchain technology. Hereinafter, description will be continued with a case where the token coin is applied as the electric power value.

For example, in the residential building 100-1 to the residential building 100-4, the token coin can be acquired as the electric power value of the electric power on the basis of the electric power generated by the photovoltaic power generation device 111. In the vehicle 200-1, the vehicle 200-2, and the vehicle 200-4, the token coin can be acquired as the electric power value of the electric power on the basis of the electric power generated by a photovoltaic power generation device 211. In the vehicle 200-3, the token coin can be acquired by paying a consideration such as purchasing with money.

An example of the electric power state is either or both of the electric power supplied from the vehicle 200 to the residential building 100 (hereinafter referred to as “supply electric power”) and the electric power used (hereinafter referred to as “use electric power”). The use electric power may be electric power used in a microgrid or electric power used in the residential building 100. Specifically, the supply electric power may be the electric power supplied from the vehicle storage battery 208 to the residential building storage battery 108, and the use electric power may be the electric power used in the HEMS 106.

FIG. 4A is a diagram for explaining Example 1 of a setting example of an electric power value of the grid system according to the present embodiment. In FIG. 4A, a horizontal axis represents external grid electric power and photovoltaic electric power, and a vertical axis represents electric power. Here, the external grid electric power is electric power supplied to the intra-regional electric power line 50 from another intra-regional electric power line that electrically connects a geographical range different from a predetermined geographical range connected by the intra-regional electric power line 50.

According to FIG. 4A, the electric power corresponding to the same token (token coin) is higher in the external grid electric power than in the photovoltaic electric power. In other words, the electric power value of the photovoltaic electric power is set to be relatively higher than the electric power value of the external grid electric power. With such a configuration, it is possible to promote the use of the photovoltaic electric power, and therefore it is possible to promote the sharing of the external grid electric power and the photovoltaic electric power.

FIG. 4B is a diagram for explaining Example 2 of a setting example of an electric power value of the grid system according to the present embodiment. In FIG. 4B, a horizontal axis represents the use electric power and the supply electric power, and a vertical axis represents the electric power.

According to FIG. 4B, the electric power corresponding to the same token (token coin) is higher in the use electric power than in the supply electric power. In other words, the electric power value of the supply electric power is set to be relatively higher than the electric power value of the use electric power. With such a configuration, it is possible to promote the supply of electric power to the residential building storage battery 108. Therefore, it is possible to promote the connection and the electric power supply to the microgrid.

According to FIGS. 4A and 4B, by introducing the photovoltaic electric power in addition to the external grid electric power, it is possible to promote decentralization of power supplies, renewable energy conversion, and local production for local consumption of energy. Returning to FIG. 2, description will be continued.

The electric power value setting unit 110 sets the electric power value of the supply electric power to be higher than the electric power value of the use electric power. When the demand for the use electric power increases, the supply electric power is supplied from the vehicle 200 to the residential building storage battery 108. However, in a case where the supply electric power supplied from the vehicle 200 to the residential building storage battery 108 increases, the SOC of the vehicle storage battery 208 becomes low, and thus it is assumed that problems occur in a case where the vehicle 200 is used.

When the electric power value of the supply electric power is set to be higher than the electric power value of the use electric power, it is assumed that the supply electric power can be reduced. Therefore, it is possible to reduce occurrence of problems in a case where the vehicle 200 is used due to the SOC of the vehicle storage battery 208 becoming low.

The electric power transfer control unit 112 acquires information specifying the electric power value set by the electric power value setting unit 110. The electric power transfer control unit 112 transfers electric power with respect to an electric power transfer control unit 212 of the vehicle 200 on the basis of the acquired information specifying the electric power value. For example, the electric power transfer control unit 112 performs control such that electric power corresponding to the electric power value to be transferred is transferred.

Specifically, in a case where the electric power stored in the residential building storage battery 108 is supplied to the vehicle 200, the electric power transfer control unit 112 acquires the electric power value according to the supplied electric power from the vehicle 200. In a case where the electric power stored in the vehicle storage battery of the vehicle 200 is supplied to the residential building 100, the electric power transfer control unit 112 outputs the electric power value according to the supplied electric power to the vehicle 200.

The storage unit 114 is realized by a hard disk drive (HDD), a flash memory, a random access memory (RAM), a read only memory (ROM), or the like.

The electric power value setting unit 110 and the electric power transfer control unit 112 are realized by, for example, a hardware processor such as a CPU executing a computer program (software) stored in the storage unit 114. Some or all of these functional units may be realized by hardware (a circuit unit: including circuitry) such as a large scale integration (LSI), an application specific integrated circuit (ASIC), a field-programmable gate array (FPGA), and a graphics processing unit (GPU) or may be realized by software and hardware in cooperation. The computer program may be stored in a storage device such as an HDD or a flash memory in advance. Alternatively, computer program may be stored in an attachable and detachable storage medium such as a DVD or a CD-ROM, or may be installed by the storage medium being attached to a drive device.

### (Vehicle 200)

The vehicle 200 includes a management unit 206, the vehicle storage battery 208, an electric power value setting unit 210, the photovoltaic power generation device 211, the electric power transfer control unit 212, and a storage unit 214.

The management unit 206 acquires information specifying the electric power stored in the vehicle storage battery 208, identification information for the residential building storage battery 108 (hereinafter referred to as “residential building storage battery ID”), and information specifying the electric power stored in the residential building storage battery 108. An example of the residential building storage battery ID is a MAC address. Hereinafter, description will be continued with a case where the MAC address is applied as the residential building storage battery ID.

The management unit 206 requests discharging to the vehicle storage battery 208 and requests charging to the residential building storage battery 108 on the basis of either or both of the acquired information specifying the electric power stored in the vehicle storage battery 208 and the acquired information specifying the electric power stored in the residential building storage battery 108.

Alternatively, the management unit 206 requests charging to the vehicle storage battery 208 and requests discharging to the residential building storage battery 108 on the basis of either or both of the acquired information specifying the electric power stored in the vehicle storage battery 208 and the acquired information specifying the electric power stored in the residential building storage battery 108.

The management unit 206 monitors the current between the vehicle storage battery 208 and the intra-regional electric power line 50 to grasp whether the vehicle storage battery 208 is charged or the vehicle storage battery 208 is discharged.

The electric power generated by the photovoltaic power generation device 211 is supplied to the vehicle storage battery 208. The vehicle storage battery 208 stores the electric power supplied from the photovoltaic power generation device 211.

The electric power value setting unit 210 sets an electric power value per a predetermined amount of the electric power with respect to the electric power value setting unit 110 of the residential building 100 on the basis of an electric power state of either or both of the vehicle storage battery 208 and the residential building storage battery 108.

An example of the electric power state is either or both of the supply electric power and the use electric power. The electric power value setting unit 210 sets the electric power value of the supply electric power to be higher than the electric power value of the use electric power. When the demand for the use electric power increases, the electric power (the supply electric power) is supplied from the vehicle 200 to the residential building storage battery 108.

However, in a case where the supply electric power supplied from the vehicle 200 to the residential building storage battery 108 increases, the SOC of the vehicle storage battery 208 becomes low, and thus it is assumed that problems occur in a case where the vehicle 200 is used.

The electric power transfer control unit 212 acquires information specifying the electric power value set by the electric power value setting unit 210. The electric power transfer control unit 212 transfers electric power with respect to an electric power transfer control unit 112 of the residential building 100 on the basis of the acquired information specifying the electric power value.

Specifically, in a case where the electric power stored in the vehicle storage battery 208 is supplied to the residential building 100, the electric power transfer control unit 212 acquires the electric power value according to the supplied electric power from the residential building 100. In a case where the electric power stored in the residential building storage battery 108 of the residential building 100 is supplied to the vehicle storage battery 208 the vehicle 200, the electric power transfer control unit 212 outputs the electric power value according to the supplied electric power to the residential building 100.

The storage unit 214 is realized by an HDD, a flash memory, a RAM, a ROM, or the like.

The management unit 206, the electric power value setting unit 210, and the electric power transfer control unit 212 are realized by, for example, a hardware processor such as a CPU executing a computer program (software) stored in the storage unit 214. Some or all of these functional units may be realized by hardware (a circuit unit: including circuitry) such as a LSI, an ASIC, a FPGA, and a GPU or may be realized by software and hardware in cooperation. The computer program may be stored in a storage device such as an HDD or a flash memory in advance. Alternatively, computer program may be stored in an attachable and detachable storage medium such as a DVD or a CD-ROM, or may be installed by the storage medium being attached to a drive device.

### (Operation of Grid System 1)

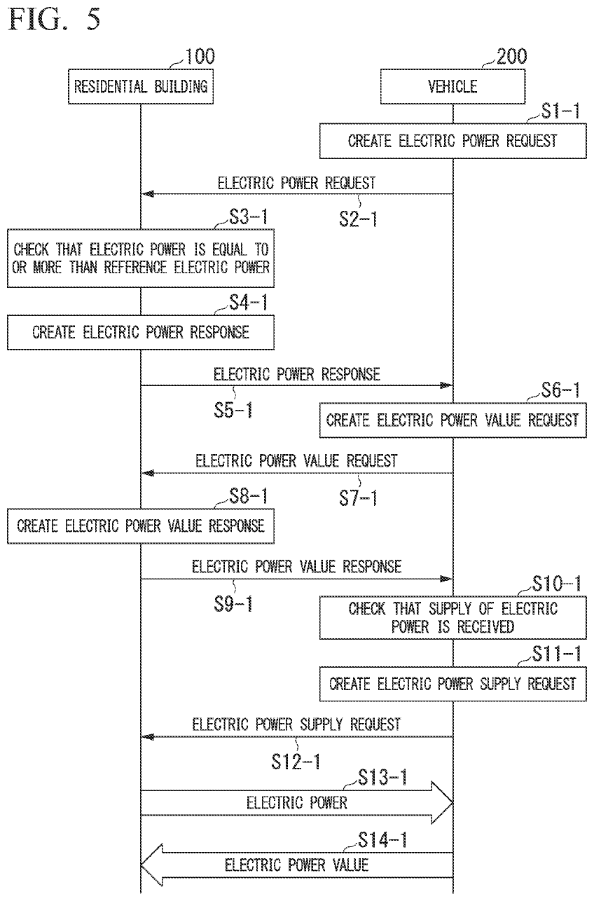

FIG. 5 is a flowchart showing an example of an operation of the grid system according to the present embodiment. As an example, a process of supplying the electric power stored in the residential building storage battery 108 of the residential building 100 to the vehicle storage battery 208 of the vehicle 200 will be described.

In the vehicle 200, the following case will be described. In this case, the management unit 206 acquires the information specifying the electric power stored in the vehicle storage battery 208, the residential building storage battery ID, and the information specifying the electric power stored in the residential building storage battery 108. Further, the management unit 206 requests charging to the vehicle storage battery 208 and requests discharging to the residential building storage battery 108 on the basis of either or both of the acquired information specifying the electric power stored in the vehicle storage battery 208 and the acquired information specifying the electric power stored in the residential building storage battery 108.

### (Step S1-1)

In the vehicle 200, the management unit 206 creates an electric power request which includes the vehicle storage battery ID and information requesting discharging and is destined for the HEMS 106 of the vehicle 200.

### (Step S2-1)

In the vehicle 200, the management unit 206 outputs the created electric power request to the electric power line. The electric power request output to the electric power line is transmitted to the HEMS 106 via the intra-regional electric power line 50, the connecting portion 116, and the distribution board 104.

### (Step S3-1)

In the residential building 100, the HEMS 106 acquires the electric power request transmitted from the vehicle 200. The HEMS 106 acquires the information requesting discharging included in the acquired electric power request. The HEMS 106 acquires the information specifying the electric power stored in the residential building storage battery 108 on the basis of the information requesting discharging.

The HEMS 106 determines whether or not the electric power which is equal to or more than the reference electric power is stored in the residential building storage battery 108 on the basis of the acquired information specifying the electric power stored in the residential building storage battery 108. The HEMS 106 determines that it is possible to supply the electric power by discharging the electric power stored in the residential building storage battery 108 in a case where the electric power is equal to or more than the reference electric power and determines that it is not possible to supply the electric power because the electric power cannot be discharged in a case where the electric power is less than a reference value.

### (Step S4-1)

In the residential building 100, the HEMS 106 creates an electric power response that includes information specifying whether or not it is possible to supply the electric power.

### (Step S5-1)

In the residential building 100, the HEMS 106 outputs the created electric power response to the electric power line. The electric power response output to the electric power line is transmitted to the vehicle 200 via the distribution board 104, the connecting portion 116, and the intra-regional electric power line 50.

### (Step S6-1)

In the vehicle 200, the management unit 206 acquires the electric power response transmitted from the residential building 100. The HEMS 106 acquires the information specifying whether or not it is possible to supply the electric power which is included in the electric power response. Here, description will be continued with a case where the electric power response includes the information specifying that it is possible to supply the electric power. Here, in a case where the electric power response includes the information specifying that it is not possible to supply the electric power, the process may return to step S1-1 and create an electric power request destined for another residential building.

The HEMS 106 starts a process of receiving the supply of electric power from the residential building 100 on the basis of the information specifying that it is not possible to supply the acquired electric power. The electric power value setting unit 210 creates an electric power value request for requesting the electric power value from the residential building 100.

### (Step S7-1)

In the vehicle 200, the electric power value setting unit 210 outputs the created electric power value request to the electric power line. The electric power value request output to the electric power line is transmitted to the residential building 100 via the intra-regional electric power line 50, the connecting portion 116, and the distribution board 104.

### (Step S8-1)

In the residential building 100, the electric power value setting unit 110 acquires the electric power value request transmitted from the vehicle 200. The electric power value setting unit 110 creates an electric power value response including the information specifying the power value on the basis of the acquired electric power value request.

### (Step S9-1)

In the residential building 100, the electric power value setting unit 110 outputs the created electric power value response to the electric power line. The electric power value response output to the electric power line is transmitted to the vehicle 200 via the distribution board 104, the connecting portion 116, and the intra-regional electric power line 50.

### (Step S10-1)

In the vehicle 200, the electric power value setting unit 210 acquires the electric power value response transmitted from the residential building 100. The electric power value setting unit 210 determines whether or not to receive the supply of electric power on the basis of the acquired electric power value response. For example, in a case where the electric power value included in the electric power value response is higher than a predetermined value, the electric power value setting unit 210 determines that the supply of electric power is not received. Here, description will be continued with a case where the electric power value setting unit 210 determines that the supply of electric power is received. Here, in a case where it is determined that the supply of electric power is not received, the process may return to step S1-1 and an electric power request destined for another residential building may be created. In a case where it is determined that the supply of electric power is received, the electric power value setting unit 210 sets the electric power value.

### (Step S11-1)

In the vehicle 200, the electric power transfer control unit 212 acquires the information specifying the electric power value set by the electric power value setting unit 210. The electric power transfer control unit 212 creates an electric power supply request including information specifying whether or not to receive the supply of electric power.

### (Step S12-1)

In the vehicle 200, the electric power transfer control unit 212 outputs the created electric power supply request to the electric power line. The electric power supply request output to the electric power line is transmitted to the residential building 100 via the intra-regional electric power line 50, the connecting portion 116, and the distribution board 104.

### (Step S13-1)

In the residential building 100, the electric power transfer control unit 112 acquires the electric power supply request transmitted from the vehicle 200. The electric power transfer control unit 112 discharges the residential building storage battery 108 on the basis of the acquired electric power supply request. When the residential building storage battery 108 is discharged, the electric power stored in the residential building storage battery 108 is supplied to the vehicle storage battery 208 of the vehicle 200 via the distribution board 104, the connecting portion 116, and the intra-regional electric power line 50. The vehicle storage battery 208 stores the supplied electric power.

### (Step S14-1)

In the vehicle 200, in a case where the supply of electric power is terminated, the electric power transfer control unit 112 outputs information specifying the electric power value corresponding to the supplied electric power to the electric power line. The information specifying the electric power value corresponding to the supplied electric power which is output to the electric power line is transmitted to the residential building 100 via the intra-regional electric power line 50, the connecting portion 116, and the distribution board 104.

In the residential building 100, the electric power transfer control unit 112 acquires the information specifying the electric power value corresponding to the supplied electric power which is transmitted from the vehicle 200.

In the flowchart shown in FIG. 5, in a case where there are a plurality of vehicles that have transmitted an electric power request to the residential building 100, the electric power transfer control unit 112 may determine a vehicle to which the electric power obtained by discharging the residential building storage battery 108 is supplied on the basis of whether or not each of the plurality of vehicles is equipped with a photovoltaic power generation device. In this case, in the vehicle 200, information specifying whether or not the photovoltaic power generation device is provided is included in the electric power request.

Specifically, the electric power transfer control unit 112 may give priority to a vehicle equipped with the photovoltaic power generation device over a vehicle not equipped with the photovoltaic power generation device. The vehicle equipped with the photovoltaic power generation device may be less likely to have an SOC lower than the vehicle not equipped with the photovoltaic power generation device. Here, in order to prevent the SOC from becoming less than a certain value, a take-out prohibition threshold value for prohibiting the take-out of electric power may be set and the SOC may be controlled so as not to be less than the take-out prohibition threshold value. In a case where the SOCs are the same, the vehicle equipped with the photovoltaic power generation device may be charged in preference to the vehicle not equipped with the photovoltaic power generation device. With such a configuration, in a case where there are the plurality of vehicles that have transmitted the electric power request to the residential building 100, a right to preferentially use the electric power can be given to the vehicle equipped with the photovoltaic power generation device, and thus it is possible to promote the vehicle 200 to have the photovoltaic power generation device.

In FIG. 5, as an example, a case where the vehicle storage battery 208 is requested to be charged and the residential building storage battery 108 is requested to be discharged has been described. However, the present invention can also be applied to a case where the vehicle storage battery 208 is requested to be discharged and the residential building storage battery 108 is requested to be charged.

In the above-described embodiment, a case where the residential building 100 and the vehicle 200 are connected through the electric power line and electric power line carrier communication is performed through the electric power line has been described, but the present invention is not limited to this example. For example, communication may be performed between the residential building 100 and the vehicle 200 using an information line, or wireless communication may be performed.

In the above-described embodiment, a case where the supply electric power and the use electric power are used as an example of the electric power state has been described, but the present invention is not limited to this example.

For example, in a case where a first consumer has either or both of the residential building storage battery 108 of the residential building 100-1 and the vehicle storage battery 208 of the vehicle 200-1, and a second consumer has either or both of the residential building storage battery 108 of the residential building 100-2 and the vehicle storage battery 208 of the vehicle 200-2, the electric power may be transferred between the first consumer and the second consumer.

In a case where the electric power is transferred between the first consumer and the second consumer, either or both of the electric power value setting unit 110 and the electric power value setting unit 210 may set the electric power value per a predetermined amount of the electric power on the basis of the electric power state of either or both of the residential building storage battery 108 of the residential building 100-2 and the vehicle storage battery 208 of the vehicle 200-2. With such a configuration, it is possible to set the electric power value per a predetermined amount of the electric power on the basis of the electric power state of either or both of the residential building storage battery 108 of the residential building 100-2 and the vehicle storage battery 208 of the vehicle 200-2.

For example, as an example of the electric power state, the electric power state of the intra-regional electric power line 50 may be applied. In this case, the electric power value setting unit 110 and the electric power value setting unit 210 may set the electric power value on the basis of the electric power state of the intra-regional electric power line 50.

Specifically, the electric power value setting unit 110 and the electric power value setting unit 210 may make the electric power value higher when the usage rate is high than when the usage rate is low on the basis of the usage state of the intra-regional electric power line 50. With such a configuration, in a case where the usage rate of the intra-regional electric power line 50 is high, the transfer of electric power between the residential building 100 and the vehicle 200 can be reduced, and thus further increase of the usage rate of the intra-regional electric power line 50 can be reduced.

For example, as an example of an electric power characteristic, the SOC of either or both of the residential building storage battery 108 and the vehicle storage battery 208 may be applied. The electric power value setting unit 110 and the electric power value setting unit 210 set an electric power value of the residential building storage battery 108 or the vehicle storage battery 208 having an SOC lower than a first reference value to be higher than an electric power value of the residential building storage battery 108 or the vehicle storage battery 208 having an SOC higher than the first reference value. With such a configuration, it is possible to reduce the discharge of the residential building storage battery 108 or the vehicle storage battery 208 having a lower SOC. Therefore, it is possible to reduce the trouble of use due to the storage battery having a lower SOC being further discharged.

In a case where the electric power value of the residential building storage battery 108 or the vehicle storage battery 208 having an SOC lower than the first reference value is set to be higher than the electric power value of the residential building storage battery 108 or the vehicle storage battery 208 having an SOC higher than the first reference value or the electric power value of the supply electric power, the electric power transfer control unit 112 and the electric power transfer control unit 212 may perform control such that the electric power is supplied to a use storage battery which is a storage battery used in the microgrid or either or both of the residential building storage battery 108 and the vehicle storage battery 208 having an SOC higher than a predetermined reference value from the intra-regional electric power line 50 in the grid system 1.

With such a configuration, it is possible to make up for the electric power shortage that may occur due to the setting of an electric power value of the residential building storage battery 108 or the vehicle storage battery 208 having an SOC lower than the first reference value to be higher than an electric power value of the residential building storage battery 108 or the vehicle storage battery 208 having an SOC higher than the first reference value.

In a case where the electric power value of the residential building storage battery 108 or the vehicle storage battery 208 having an SOC lower than the first reference value is set to be higher than the electric power value of the residential building storage battery 108 or the vehicle storage battery 208 having an SOC higher than the first reference value or the electric power value of the supply electric power, the electric power may be transferred between the first consumer having the residential building storage battery 108 of the residential building 100-1 or the vehicle storage battery 208 of the vehicle 200-1 and the second consumer having the residential building storage battery 108 of the residential building 100-2 or the vehicle storage battery 208 of the vehicle 200-2.

In this case, the electric power transfer control unit 112 and the electric power transfer control unit 212 may perform control such that the electric power is supplied to the residential building storage battery 108 or either or both of the residential building storage battery 108 and the vehicle storage battery 208 having an SOC higher than a predetermined reference value from either or both of the residential building storage battery 108 of the residential building 100-2 and the vehicle storage battery 208 of the vehicle 200-2. With such a configuration, it is possible to make up for the electric power shortage that may occur due to the setting of an electric power value of the residential building storage battery 108 or the vehicle storage battery 208 having an SOC lower than the first reference value to be higher than an electric power value of the residential building storage battery 108 or the vehicle storage battery 208 having an SOC higher than the first reference value.

In a case where the electric power value of the residential building storage battery 108 or the vehicle storage battery 208 having an SOC lower than the first reference value is set to be higher than the electric power value of the residential building storage battery 108 or the vehicle storage battery 208 having an SOC higher than the first reference value, the electric power transfer control unit 112 and the electric power transfer control unit 212 may perform control such that the electric power is supplied to the residential building storage battery 108 or either or both of the residential building storage battery 108 and the vehicle storage battery 208 having an SOC higher than a predetermined reference value from either or both of the photovoltaic power generation device 111 and the photovoltaic power generation device 211.

With such a configuration, it is possible to make up for the electric power shortage that may occur due to the setting of an electric power value of the residential building storage battery 108 or the vehicle storage battery 208 having an SOC lower than the first reference value to be higher than an electric power value of the residential building storage battery 108 or the vehicle storage battery 208 having an SOC higher than the first reference value.

The electric power value setting unit 110 may increase or decrease the electric power value of the residential building storage battery 108 on the basis of the increase or decrease of the SOC of the residential building storage battery 108. Specifically, the electric power value setting unit 110 may decrease the electric power value of the residential building storage battery 108 in a case where the SOC of the residential building storage battery 108 increases and may increase the electric power value of the residential building storage battery 108 in a case where the SOC of the residential building storage battery 108 decreases.

The electric power value setting unit 210 may increase or decrease the electric power value of the vehicle storage battery 208 on the basis of the increase or decrease of the SOC of the vehicle storage battery 208. Specifically, the electric power value setting unit 210 may decrease the electric power value of the vehicle storage battery 208 in a case where the SOC of the vehicle storage battery 208 increases and may increase the electric power value of the vehicle storage battery 208 in a case where the SOC of the vehicle storage battery 208 decreases.

The electric power value setting unit 110 and the electric power value setting unit 210 may determine whether or not it is necessary to increase the SOC of the residential building storage battery 108 on the basis of whether or not the user is in the residential building 100 and may set the electric power value on the basis of the determination result. Specifically, the electric power value setting unit 110 and the electric power value setting unit 210 may determine that it is not necessary to increase the SOC of the residential building storage battery 108 in a case where a user is not in the residential building 100 and may lower the electric power value of the residential building storage battery 108. The electric power value setting unit 110 and the electric power value setting unit 210 may determine that it is necessary to increase the SOC of the residential building storage battery 108 in a case where there is a user in the residential building 100 and may increase the electric power value of the residential building storage battery 108.

The electric power value setting unit 110 and the electric power value setting unit 210 may determine whether or not it is necessary to increase the SOC of the vehicle storage battery 208 on the basis of whether or not the user is in the vehicle 200 and may set the electric power value on the basis of the determination result. Specifically, the electric power value setting unit 110 and the electric power value setting unit 210 may determine that it is not necessary to increase the SOC of the vehicle storage battery 208 in a case where a user is not in the vehicle 200 and may lower the electric power value of the vehicle storage battery 208. The electric power value setting unit 110 and the electric power value setting unit 210 may determine that it is necessary to increase the SOC of the vehicle storage battery 208 in a case where there is a user in the vehicle 200 and may increase the electric power value of the vehicle storage battery 208.

In the above-described embodiment, a case where the vehicle storage battery 208 of the vehicle 200 receives the supply of electric power via a cable has been described, but the present invention is not limited to this example. For example, the intra-regional electric power line 50 and the vehicle 200 may be electrically connected in a non-contact manner to supply the electric power from the residential building 100 and to charge the vehicle storage battery 208.

Specifically, a power transmission and reception circuit having a coil is provided in a parking space or the like, and the power transmission and reception circuit is connected to the distribution board 104 via the intra-regional electric power line 50. The vehicle 200 includes a power transmission and reception circuit having a coil, and the power transmission and reception circuit is connected to the vehicle storage battery 208.

When the vehicle storage battery 208 is charged, electric power is supplied from the distribution board 104 to the power transmission and reception circuit on side of the parking space to energize the coil, and thus the electric power is supplied to the coil on a side of the vehicle due to electromagnetic induction action and the vehicle storage battery 208 is charged via the power transmission and reception circuit.

When electric power is supplied from the vehicle storage battery 208, the electric power of the vehicle storage battery 208 is used to energize the coil on a side of the vehicle, and thus the electric power is supplied to the coil on a side of the parking space due to electromagnetic induction action and the electric power is supplied to the distribution board 104 via the power transmission and reception circuit.

In the above-described embodiment, a case where electric power is transferred between each of the residential building 100-1 to the residential building 100-4 and each of the vehicle 200-1 to the vehicle 200-4 which are connected to the intra-regional electric power line 50 has been described, but the present invention is not limited to this example.

For example, the vehicle 200 may acquire external grid electric power for use inside the intra-regional electric power line 50 and may supply the acquired external grid electric power to the intra-regional electric power line 50. In this case, an electric power value of the external grid electric power may be set to be lower than an electric power value of the electric power inside the intra-regional electric power line 50. With such a configuration, it is assumed that the use of the external grid electric power having a lower electric power value is promoted, and thus the distribution of the external grid electric power can be promoted.

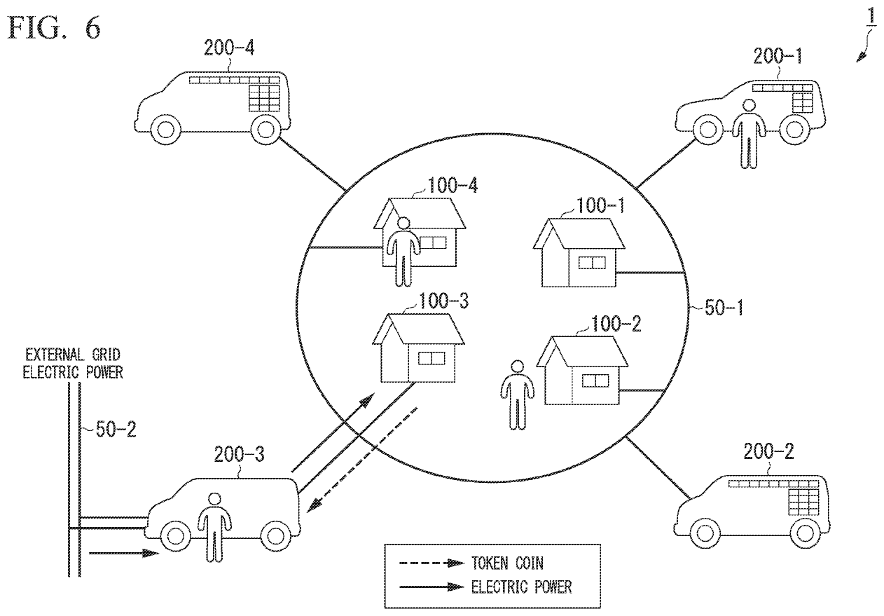

FIG. 6 is a diagram showing Example 2 of a schematic configuration of a grid system according to the present embodiment. Each of the residential building 100-1 to the residential building 100-4 is connected to a first intra-regional electric power line 50-1 and receives supply of electric power from the first intra-regional electric power line 50-1. The vehicle 200-1 is connected to the first intra-regional electric power line 50-1 in the vicinity of the residential building 100-1, the vehicle 200-2 is connected to the first intra-regional electric power line 50-1 in the vicinity of the residential building 100-2, the vehicle 200-3 is connected to the first intra-regional electric power line 50-1 in the vicinity of the residential building 100-3, and the vehicle 200-4 is connected to the first intra-regional electric power line 50-1 in the vicinity of the residential building 100-4.

Among the vehicle 200-1 to the vehicle 200-4, the vehicle 200-3 is connected to a second intra-regional electric power line 50-2 in addition to the first intra-regional electric power line 50-1. The vehicle 200-3 stores the external grid electric power supplied from the second intra-regional electric power line 50-2 in the vehicle storage battery 208. The vehicle 200-3 can supply the electric power stored in the vehicle storage battery 208 to the first intra-regional electric power line 50-1. The electric power supplied to the power line 50-1 in the first area from the vehicle 200-3 can be supplied to any one of each of the residential building 100-1 to the residential building 100-4, the vehicle 200-1, the vehicle 200-2, and the vehicle 200-4 which are connected to the first intra-regional electric power line 50-1.

In other words, the vehicle 200-3 relays the electric power between the first intra-regional electric power line 50-1 and the second intra-regional electric power line 50-2. In a case where the vehicle 200-3 supplies the external grid electric power stored in the vehicle storage battery 208 to the first intra-regional electric power line 50-1, the vehicle 200-3 sets the electric power value of the external grid electric power to be lower than the electric power value of the first intra-regional electric power line 50-1.

Specifically, in the vehicle 200-3, in a case where the electric power value setting unit 110 sets the electric power value per a predetermined amount of electric power according to the electric power state, the electric power value setting unit 110 uses either or both of electric power transmitted in the first intra-regional electric power line 50-1 (hereinafter referred to as “grid internal electric power”) and electric power supplied from the second intra-regional electric power line 50-2 different from the first intra-regional electric power line 50-1 to the first intra-regional electric power line 50-1 (hereinafter referred to “grid external electric power”) as an example of the electric power state. Here, description will be continued with a case where the grid internal electric power and the grid external electric power are used as an example of the electric power state. The grid external electric power is supplied from the second intra-regional electric power line 50-2 to the first intra-regional electric power line 50-1 via a relay device such as the vehicle 200-3.

The electric power value setting unit 110 and the electric power value setting unit 210 set the electric power value of the grid external electric power to be lower than the electric power value of the grid internal electric power. In other words, the electric power value setting unit 110 and the electric power value setting unit 210 set the electric power value of the grid internal electric power to be higher than the electric power value of the grid external electric power. With such a configuration, in a case where the demand for the grid internal electric power increases, the distribution of the grid external electric power can be promoted.

For example, in the vehicle 200-3, the electric power value setting unit 110 derives the total of SOCs of the electric power stored in the residential building 100-1 to the residential building 100-4 and the vehicle 200-1 to the vehicle 200-4 which are connected to the first intra-regional electric power line 50-1. In a case where the total of the derived SOCs is lower than a predetermined reference value (a second reference value), the electric power value setting unit 110 and the electric power value setting unit 210 set the electric power value of the grid external electric power to be higher than the electric power value of the grid internal electric power.

With such a configuration, even in a case where the SOC inside the first intra-regional electric power line 50-1 is low and the demand is high as compared with in a case where the electric power value of the grid external electric power is set to be lower than the electric power value of the grid internal electric power, it is possible to reduce a situation that the grid external electric power is simply passed to a place where the SOC is low. Therefore, it is possible to reduce the electric power shortage that may occur due to the simply passing of the electric power of the external grid to a place where the SOC is low.

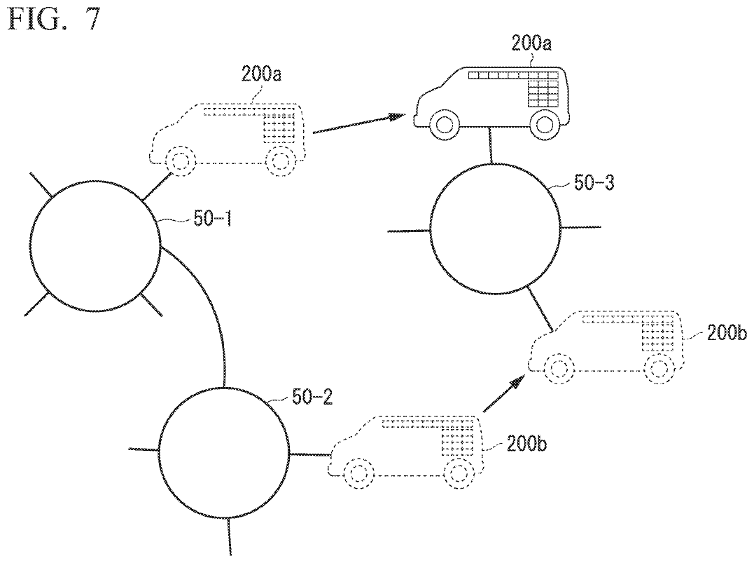

In the above-described embodiment, the vehicle 200 may be used to transfer the electric power. FIG. 7 is a diagram showing Example 3 of a schematic configuration of a grid system according to the present embodiment. FIG. 7 shows a first intra-regional electric power line 50-1, a second intra-regional electric power line 50-2, and a third intra-regional electric power line 50-3.

As a vehicle 200a, the vehicle 200 described above can be applied. The vehicle 200a connected to the first intra-regional electric power line 50-1 is supplied with electric power via the first intra-regional electric power line 50-1, and the supplied electric power is stored in the vehicle storage battery 208. After that, the vehicle 200a moves to be connected to the third intra-regional electric power line 50-3 and to supply the electric power to the third intra-regional electric power line 50-3. With such a configuration, the electric power can be transferred from a predetermined geographical range connected through the first intra-regional electric power line 50-1 to a predetermined geographical range connected through the third intra-regional electric power line 50-3 using the vehicle 200a.

Further, as a vehicle 200b, the vehicle 200 described above can be applied. The vehicle 200b connected to the second intra-regional electric power line 50-2 is supplied with electric power via the second intra-regional electric power line 50-2, and the supplied electric power is stored in the vehicle storage battery 208. After that, the vehicle 200b moves to be connected to the third intra-regional electric power line 50-3 and to supply the electric power to the third intra-regional electric power line 50-3. With such a configuration, the electric power can be transferred from a predetermined geographical range connected through the second intra-regional electric power line 50-2 to a predetermined geographical range connected through the third intra-regional electric power line 50-3 using the vehicle 200b.

In a predetermined geographical range connected through the third intra-regional electric power line 50-3, it is possible to receive supply of the electric power transferred using the vehicle 200a and the electric power transferred using the vehicle 200b.

In the above-described embodiment, in a case where there are the electric power transferred to the intra-regional electric power line 50 using the vehicle 200 (hereinafter referred to as “mobile electric power”) and the electric power stored in the vehicle 200 (not shown) connected to the intra-regional electric power line 50 (hereinafter referred to as “connection electric power”), either or both of the mobile electric power and the connection electric power may be applied as an example of an electric power characteristic.

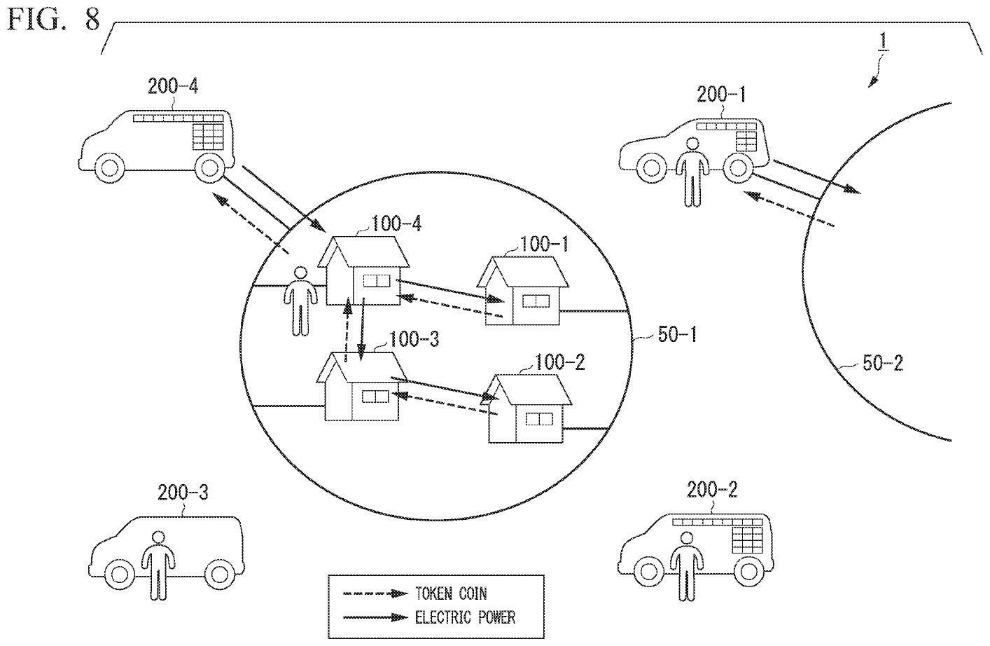

FIG. 8 is a diagram showing Example 4 of a schematic configuration of a grid system according to the present embodiment. FIG. 8 shows a first intra-regional electric power line 50-1 and a second intra-regional electric power line 50-2. The residential building 100-1 to the residential building 100-4 are connected to the first intra-regional electric power line 50-1 via the electric power line. The vehicle 200-1 is connected to the second intra-regional electric power line 50-2 via the electric power line.

Temporarily, the vehicle 200-1 is supplied with electric power via the first intra-regional electric power line 50-1, the supplied electric power is stored in the vehicle storage battery 208, and then the vehicle 200-1 moves to a predetermined geographical range connected through the second intra-regional electric power line 50-2. In this case, the vehicle 200-1 can supply the electric power to the second intra-regional electric power line 50-2 by being connected to the second intra-regional electric power line 50-2. Here, as an example of the electric power characteristic, either or both of the mobile electric power and the connection electric power may be applied. For example, the electric power value setting unit 110 may set an electric power value of the connection electric power to be higher than an electric power value of the mobile electric power. With such a configuration, in a case where the demand for the electric power increases in the second intra-regional electric power line 50-2, the distribution of the mobile electric power can be promoted.

According to the grid system 1 of the present embodiment, in the grid system 1, a first storage battery as the residential building storage battery 108 and a second storage battery as the vehicle storage battery 208 can be connected, and electric power can be transferred between the first storage battery and the second storage battery. The grid system 1 includes an electric power value setting unit (110, 210) that sets an electric power value per a predetermined amount of electric power according to an electric power state of either or both of the first storage battery and the second storage battery and an electric power transfer control unit (112, 212) that adjusts an amount of electric power to be transferred between the first storage battery and the second storage battery on the basis of the electric power value.

With such a configuration, the value of electric power can be adjusted, and thus the amount of electric power transferred between the first storage battery and the second storage battery can be adjusted. Since the amount of electric power transferred between the first storage battery and the second storage battery can be adjusted, in the vehicle 200 equipped with the vehicle storage battery 208, the fluidity of the electric power is increased and a local and low-priced power supply network can be established.

The first storage battery is a residential building storage battery installed in a residential building and the residential building storage battery stores electric power generated by a photovoltaic power generation device installed in the residential building, and the second storage battery is a vehicle storage battery installed in a vehicle and the vehicle storage battery stores electric power generated by a photovoltaic power generation device installed in the vehicle. With such a configuration, since the amount of electric power transferred between the residential building storage battery and the vehicle storage battery can be adjusted, in the vehicle 200 equipped with the vehicle storage battery 208, the fluidity of the electric power is increased and a local and low-priced power supply network can be established.

A first consumer having either or both of the first storage battery and the second storage battery can transfer electric power with respect to a second consumer having a third storage battery, and the electric power value setting unit sets an electric power value per a predetermined amount of electric power on the basis of an electric power state of the third storage battery in a case where electric power is transferred between the first consumer and the second consumer. With such a configuration, it is possible to set the electric power value per a predetermined amount of the electric power on the basis of the electric power state of the third storage battery.

The grid system 1 includes an intra-regional electric power line 50 that electrically connects a predetermined geographical range. The electric power value setting unit sets an electric power value per a predetermined amount of electric power on the basis of an electric power state of the intra-regional electric power line 50. With such a configuration, in a case where the usage rate of the intra-regional electric power line 50 is high, the transfer of electric power between the residential building 100 and the vehicle 200 can be reduced, and thus further increase of the usage rate of the intra-regional electric power line 50 can be reduced.

The second storage battery is a vehicle storage battery installed in a vehicle and the vehicle storage battery stores electric power generated by a photovoltaic power generation device installed in the vehicle. The electric power transfer control unit gives priority to a vehicle having the photovoltaic power generation device over other vehicles not having the photovoltaic power generation device. With such a configuration, a right to preferentially use the electric power can be given to the vehicle equipped with the photovoltaic power generation device, and thus it is possible to promote the vehicle to have the photovoltaic power generation device mounted thereon.

The electric power state includes use electric power and supply electric power which is electric power supplied from the vehicle 200 to the residential building 100. The electric power value setting unit sets the electric power value of the supply electric power to be higher than the electric power value of the use electric power. With such a configuration, it is possible to promote the supply of electric power from the vehicle 200 to the residential building 100. Therefore, it is possible to promote the connection and the electric power supply to the microgrid.

The first storage battery is a residential building storage battery 108 installed in a residential building 100 and the second storage battery is a vehicle storage battery 208 installed in a vehicle 200, and the electric power value setting unit lowers an electric power value of the residential building storage battery 108 in a case where a user is not in the residential building 100 and lowers an electric power value of the vehicle storage battery 208 in a case where a user is not in the vehicle 200. With such a configuration, it is possible to set the electric power value on the basis of whether or not the user is present.

The electric power state includes an SOC of a storage battery. The electric power value setting unit sets an electric power value of the first storage battery or the second storage battery having an SOC lower than a first reference value to be higher than an electric power value of the first storage battery or the second storage battery having an SOC higher than the first reference value. With such a configuration, it is possible to reduce the discharge of the storage battery having a lower SOC. Therefore, it is possible to reduce the trouble of use due to the storage battery having a lower SOC being further discharged.

The electric power state includes an SOC of a storage battery, and the electric power value setting unit increases or decreases the electric power value on the basis of an increase or decrease of the SOC. With such a configuration, it is possible to set the electric power value on the basis of the SOC of the storage battery.

The grid system 1 includes a first intra-regional electric power line 50-1 that electrically connects a predetermined geographical range. The electric power state includes connection electric power which is electric power supplied from the first intra-regional electric power line 50-1 and mobile electric power which is electric power supplied from the outside of the first intra-regional electric power line 50-1. The electric power value setting unit sets an electric power value of the connection electric power to be higher than an electric power value of the mobile electric power. With such a configuration, in a case where the demand for the electric power increases in the first intra-regional electric power line 50-1, the distribution of the mobile electric power can be promoted.

The electric power state includes a first intra-grid electric power transmitted through a first intra-regional electric power line 50-1 that electrically connects a predetermined geographical range and a second intra-grid electric power supplied to the first intra-regional electric power line 50-1 from a second intra-regional electric power line 50-2 different from the first intra-regional electric power line 50-1. The electric power value setting unit sets an electric power value of the first intra-grid electric power to be higher than an electric power value of the second intra-grid electric power. With such a configuration, in a case where the demand for the grid internal electric power increases, the distribution of the grid external electric power can be promoted.

The electric power state includes a first grid internal electric power transmitted through a first intra-regional electric power line that electrically connects a predetermined geographical range and a second grid internal electric power supplied to the first intra-regional electric power line from a second intra-regional electric power line different from the first intra-regional electric power line. In a case where the total of SOCs of the first grid internal electric power is lower than a second reference value, the electric power value setting unit sets an electric power value of the second grid internal electric power to be higher than an electric power value of the first grid internal electric power.

With such a configuration, in a case where the demand for the first grid internal electric power increases, the distribution of the second grid internal electric power can be promoted.

The grid system 1 includes an intra-regional electric power line 50 that electrically connects a predetermined geographical range. The electric power transfer control unit performs control such that electric power is supplied from the intra-regional electric power line 50 to a use storage battery or either or both of the residential building storage battery 108 and the vehicle storage battery 208 having a SOC higher than a predetermined reference value. With such a configuration, it is possible to make up for the electric power shortage that may occur due to the setting of an electric power value of the residential building storage battery 108 or the vehicle storage battery 208 having an SOC lower than a predetermined reference value to be higher than an electric power value of the residential building storage battery 108 or the vehicle storage battery 208 having an SOC higher than the predetermined reference value.

A first consumer having either or both of the first storage battery and the second storage battery can transfer electric power with respect to a second consumer having a third storage battery. The electric power transfer control unit performs control such that electric power is supplied from the third storage battery to a use storage battery or either or both of the first storage battery and the second storage battery having a SOC higher than a predetermined reference value. With such a configuration, it is possible to make up for the electric power shortage that may occur due to the setting of an electric power value of the residential building storage battery 108 or the vehicle storage battery 208 having an SOC lower than a predetermined reference value to be higher than an electric power value of the residential building storage battery 108 or the vehicle storage battery 208 having an SOC higher than the predetermined reference value.

The electric power transfer control unit performs control such that electric power is supplied from a photovoltaic power generation device to a use storage battery or either or both of the first storage battery and the second storage battery having a SOC higher than a predetermined reference value.

With such a configuration, it is possible to make up for the electric power shortage that may occur due to the setting of an electric power value of the residential building storage battery 108 or the vehicle storage battery 208 having an SOC lower than a predetermined reference value to be higher than an electric power value of the residential building storage battery 108 or the vehicle storage battery 208 having an SOC higher than the predetermined reference value.

Although forms for carrying out the present invention have been described above using the embodiments, the present invention is not limited to these embodiments, and various modifications and substitutions can be made without departing from the gist of the present invention.

What is claimed is:

1. A grid system in which a first storage battery and a second storage battery can be connected and electric power can be transferred between the first storage battery and the second storage battery, the grid system comprising:
an electric power value setting unit that sets an electric power value per a predetermined amount of electric power according to an electric power state of either or both of the first storage battery and the second storage battery; and
an electric power transfer control unit that adjusts an amount of electric power to be transferred between the first storage battery and the second storage battery on the basis of the electric power value.

2. The grid system according to claim 1,
wherein the first storage battery is a residential building storage battery installed in a residential building and the residential building storage battery stores electric power generated by a photovoltaic power generation device installed in the residential building, and
wherein the second storage battery is a vehicle storage battery installed in a vehicle and the vehicle storage battery stores electric power generated by a photovoltaic power generation device installed in the vehicle.

3. The grid system according to claim 1,
wherein a first consumer having either or both of the first storage battery and the second storage battery can transfer electric power with respect to a second consumer having a third storage battery, and
wherein the electric power value setting unit sets an electric power value per a predetermined amount of electric power on the basis of an electric power state of the third storage battery in a case where electric power is transferred between the first consumer and the second consumer.

4. The grid system according to claim 1, further comprising:
an intra-regional electric power line that electrically connects a predetermined geographical range,
wherein the electric power value setting unit sets an electric power value per a predetermined amount of electric power on the basis of an electric power state of the intra-regional electric power line.

5. The grid system according to claim 1,
wherein the second storage battery is a vehicle storage battery installed in a vehicle and the vehicle storage battery stores electric power generated by a photovoltaic power generation device installed in the vehicle, and
wherein the electric power transfer control unit gives priority to a vehicle having the photovoltaic power generation device over other vehicles not having the photovoltaic power generation device.

6. The grid system according to claim 1,
wherein the electric power state includes use electric power and supply electric power which is electric power supplied from the vehicle to the residential building, and
wherein the electric power value setting unit sets an electric power value of the supply electric power to be higher than an electric power value of the use electric power.

7. The grid system according to claim 1,
wherein the first storage battery is a residential building storage battery installed in a residential building and the second storage battery is a vehicle storage battery installed in a vehicle, and
wherein the electric power value setting unit lowers an electric power value of the residential building storage battery in a case where a user is not in the residential building and lowers an electric power value of the vehicle storage battery in a case where a user is not in the vehicle.

8. The grid system according to claim 1,
wherein the electric power state includes an SOC of a storage battery, and
wherein the electric power value setting unit sets an electric power value of the first storage battery or the second storage battery having an SOC lower than a first reference value to be higher than an electric power value of the first storage battery or the second storage battery having an SOC higher than the first reference value.

9. The grid system according to claim 1,
wherein the electric power state includes an SOC of a storage battery, and
wherein the electric power value setting unit increases or decreases the electric power value on the basis of an increase or decrease of the SOC.

10. The grid system according to claim 1, further comprising:
a first intra-regional electric power line that electrically connects a predetermined geographical range,
wherein the electric power state includes connection electric power which is electric power supplied from the first intra-regional electric power line and mobile electric power which is electric power supplied from the outside of the first intra-regional electric power line, and
wherein the electric power value setting unit sets an electric power value of the connection electric power to be higher than an electric power value of the mobile electric power.

11. The grid system according to claim 1,
wherein the electric power state includes a first intra-grid electric power transmitted through a first intra-regional electric power line that electrically connects a predetermined geographical range and a second intra-grid electric power supplied to the first intra-regional electric power line from a second intra-regional electric power line different from the first intra-regional electric power line, and
wherein the electric power value setting unit sets an electric power value of the first intra-grid electric power to be higher than an electric power value of the second intra-grid electric power.

12. The grid system according to claim 1,
wherein the electric power state includes a first grid internal electric power transmitted through a first intra-regional electric power line that electrically connects a predetermined geographical range and a second grid internal electric power supplied to the first intra-regional electric power line from a second intra-regional electric power line different from the first intra-regional electric power line, and
wherein, in a case where the total of SOCs of the first grid internal electric power is lower than a second reference value, the electric power value setting unit sets an electric power value of the second grid internal electric power to be higher than an electric power value of the first grid internal electric power.

13. The grid system according to claim 1, further comprising:
an intra-regional electric power line that electrically connects a predetermined geographical range,
wherein the electric power transfer control unit performs control such that electric power is supplied from the intra-regional electric power line to a use storage battery or either or both of the first storage battery and the second storage battery having an SOC higher than a predetermined reference value.

14. The grid system according to claim 1,
wherein a first consumer having either or both of the first storage battery and the second storage battery can transfer electric power with respect to a second consumer having a third storage battery, and
wherein the electric power transfer control unit performs control such that electric power is supplied from the third storage battery to a use storage battery or either or both of the first storage battery and the second storage battery having an SOC higher than a predetermined reference value.

15. The grid system according to claim 1, wherein the electric power transfer control unit performs control such that electric power is supplied from a photovoltaic power generation device to a use storage battery or either or both of the first storage battery and the second storage battery having an SOC higher than a predetermined reference value.

16. An electric power transfer method executed by a grid system in which a first storage battery and a second storage battery can be connected and electric power can be transferred between the first storage battery and the second storage battery, the method comprising:
a step of setting an electric power value per a predetermined amount of electric power according to an electric power state of either or both of the first storage battery and the second storage battery; and
a step of adjusting an amount of electric power to be transferred between the first storage battery and the second storage battery on the basis of the electric power value.

17. A computer-readable non-transitory storage medium that stores a computer program causing a computer to execute:
a step of setting an electric power value per a predetermined amount of electric power according to an electric power state of either or both of a first storage battery and a second storage battery; and
a step of adjusting an amount of electric power to be transferred between the first storage battery and the second storage battery on the basis of the electric power value.
